(19) United States
(12) Patent Application Publication
(10) Pub. No.: US 2019/0143153 A1
(43) Pub. Date: May 16, 2019

(54) Shell Structure And Mask Including Same

(71) Applicant: 3M INNOVATIVE PROPERTIES COMPANY, St. Paul, MN (US)

(72) Inventors: Jin-Ho Lee, Seoul (KR); Jungchul Moon, Hwaseong-si (KR)

(21) Appl. No.: 16/188,360

(22) Filed: Nov. 13, 2018

(30) Foreign Application Priority Data
Nov. 13, 2017 (KR) 10-2017-0150819

(51) Int. Cl. A62B 18/08; A62B 18/02; A62B 23/02; A62B 7/10

(52) U.S. Cl. CPC A62B 18/08; A62B 18/025; A62B 18/10; A62B 7/10; A62B 23/025

(57) ABSTRACT

A shell structure according to an embodiment of the present disclosure, which may be provided for a shape of a mask, includes a circumferential part forming an edge, and an arch-shaped curved part integrally formed with the circumferential part at an inner side of the circumferential part, wherein a groove part is formed along a vertical central line of the curved part at a rear surface of the curved part such that the curved part is formed to be foldable about the groove part as a central line.

### TECHNICAL FIELD

The present disclosure relates to a shell structure and mask including the same.

### BACKGROUND

Masks, which are used to prevent introduction of impurities or contaminants into respiratory pathways of users, may be classified into masks including a separate filter part and filter face masks in which a mask main body itself functions as a filter.

In this case, generally, the filter face masks may be classified into masks having two different structures, that is, a fold-flat mask and a shaped mask. The fold-flat mask has a structure in which the mask is stored in a flat state but is unfolded in a cup shape upon use, and the shaped mask has a structure in which the mask has a face-fitting configuration such that the mask is manufactured in a predetermined shape, e.g., a cup shape, and maintains such a shape during use.

### SUMMARY

In a conventional mask manufactured in a cup shape, in a case in which the mask has to be folded when the use of the mask is finished or for the purpose of storage, there are problems in that the mask may not be easily folded due to the stiffness of the mask itself, and once the mask is folded, the mask is not easily restored to its original shape even when an external force is removed therefrom.

To solve such problems of the related art, an object of the present disclosure is to provide a shell structure, which is easily foldable by an external force but is easily restorable to its original shape after an external force is removed therefrom, and a mask including the same.

A shell structure according to an embodiment of the present disclosure, which is provided for a shape of a mask, includes a circumferential part forming an edge, and an arch-shaped curved part integrally formed with the circumferential part at an inner side of the circumferential part, wherein a groove part is formed along a vertical central line of the curved part at a rear surface of the curved part such that the curved part is formed to be foldable about the groove part as a central line.

A mask according to another embodiment of the present disclosure includes a shell structure according to embodiments of the present disclosure, and a filter structure coupled to a front surface of the shell structure and configured to perform an air filtering function.

The shell structure and mask including the same according to an embodiment of the present disclosure can be provided to be foldable by an external force and can be easily restorable to its original shape after an external force is removed therefrom.

### BRIEF DESCRIPTION OF THE DRAWINGS

FIG. 1 is a perspective view of a mask according to an embodiment of the present disclosure.

FIG. 2 is an exploded perspective view of the mask according to the embodiment of the present disclosure.

FIG. 3 is a rear perspective view of a shell structure according to an embodiment of the present disclosure.

FIG. 4 is a rear view of the shell structure according to the embodiment of the present disclosure.

FIG. 5 is a cross-sectional view taken along line A-A′ in FIG. 2.

FIG. 6 is an exploded perspective view of a mask according to another embodiment of the present disclosure.

FIG. 7 is a rear perspective view of a shell structure according to another embodiment of the present disclosure.

FIG. 8 is a cross-sectional view taken along line B-B′ in FIG. 6.

### DETAILED DESCRIPTION

Hereinafter, specific embodiments for implementing the idea of the present disclosure will be described in detail with reference to the accompanying drawings. In this case, note that the drawings are not drawn to scale for convenience of description. In addition, in describing the present disclosure, when detailed description of a related known configuration or function is deemed as having the possibility of blurring the gist of the present disclosure, the detailed description thereof will be omitted.

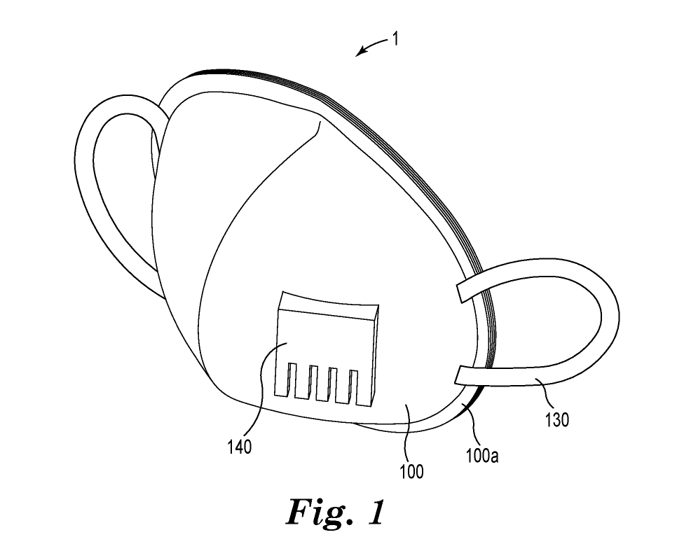

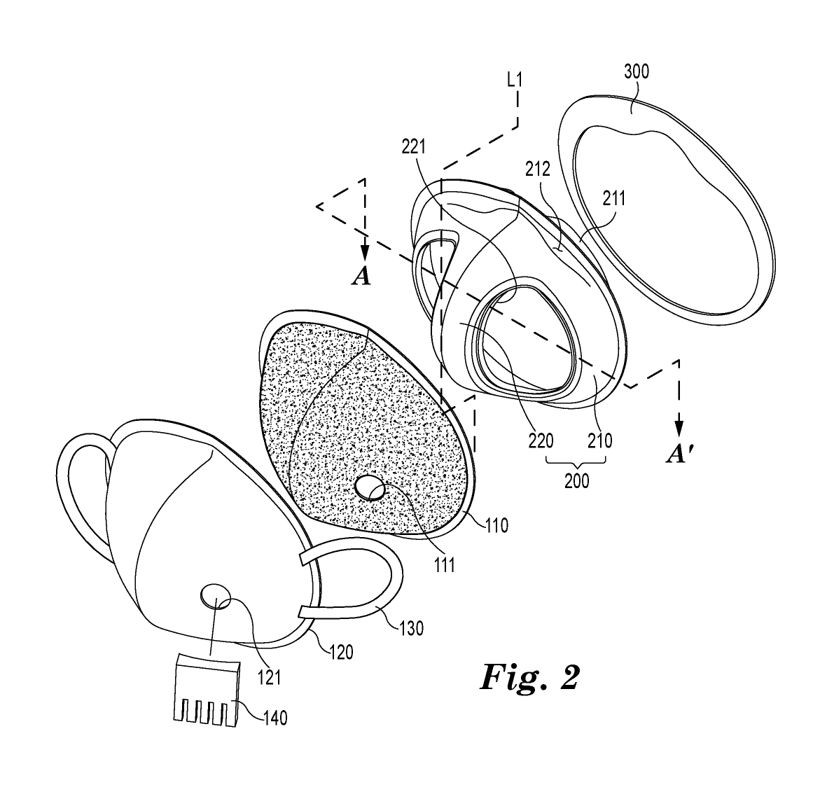

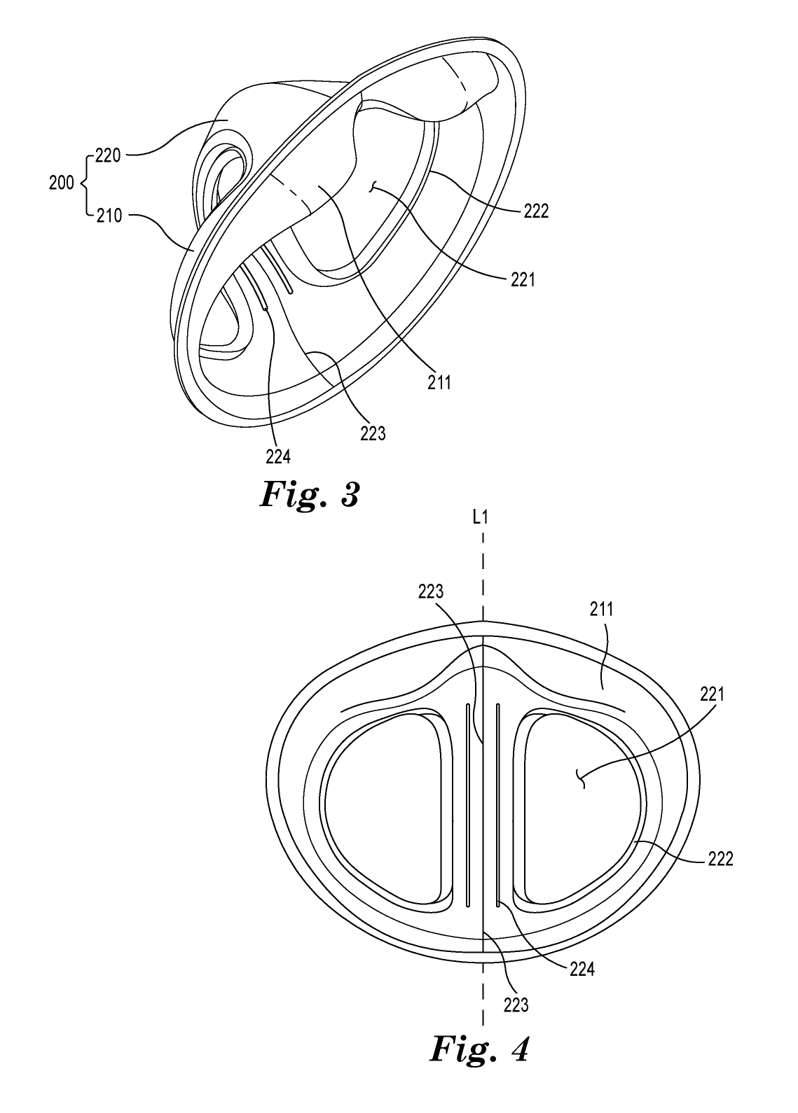

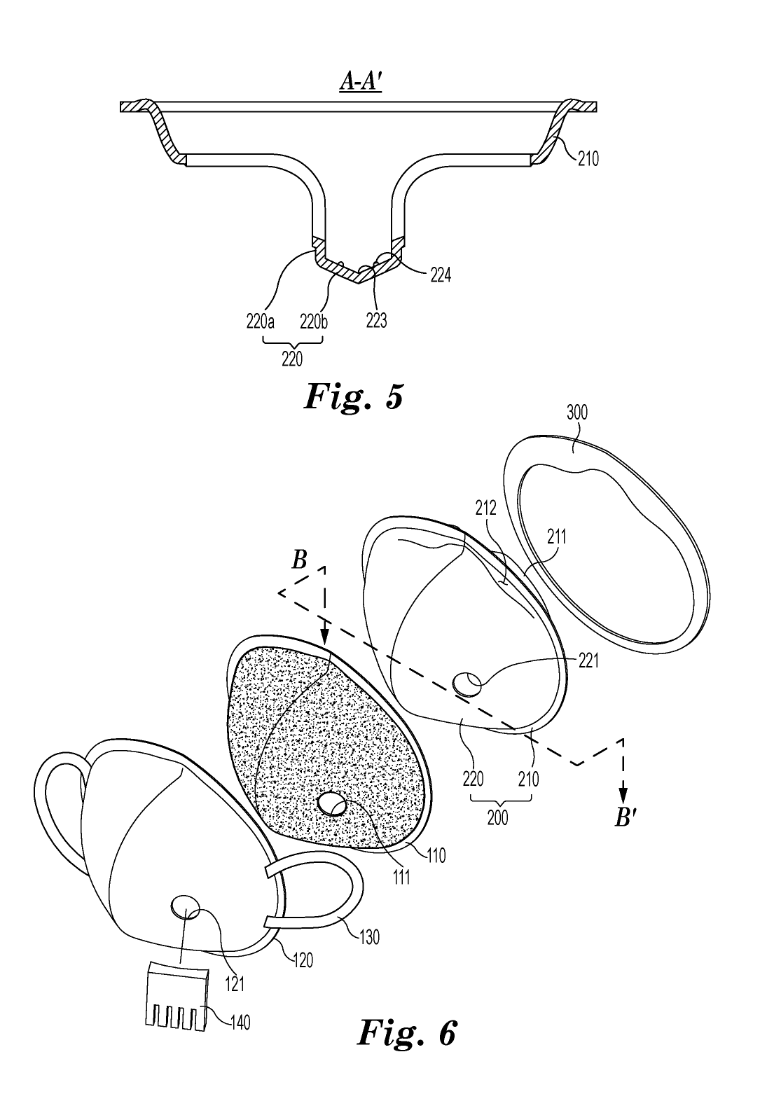

FIG. 1 is a perspective view of a mask according to an embodiment of the present disclosure, FIG. 2 is an exploded perspective view of the mask according to the embodiment of the present disclosure, FIG. 3 is a rear perspective view of a shell structure according to an embodiment of the present disclosure, FIG. 4 is a rear view of the shell structure according to the embodiment of the present disclosure, and FIG. 5 is a cross-sectional view taken along line A-A′ in FIG. 2.

Referring to FIGS. 1 to 5, a mask 1 according to an embodiment of the present disclosure may be provided as a mask that is manufactured in a predetermined shape and is capable of maintaining the corresponding shape during use. For example, the mask 1 may be manufactured to have an arch-shaped outer surface and a cup shape as a whole.

The mask 1 may include a shell structure 200 provided to maintain the shape of the mask 1 and a filter structure 100 coupled to a front surface of the shell structure 200 and configured to perform an air filtering function.

The filter structure 100, which is provided to remove impurities from air passing through the filter structure 100 and filter the air, may form a front surface of the mask 1, and a circumferential part 100a of the filter structure 100 may be coupled to a circumferential part 210 of the shell structure 200 which will be described below. At this time, the circumferential part 100a of the filter structure 100 and the circumferential part 210 of the shell structure 200 may be coupled using various methods, e.g., a heat welding or ultrasonic welding method.

The filter structure 100 may be manufactured in a multilayer shape in which a plurality of sheets are laminated. For example, the filter structure 100 may include a filter layer 110 provided for filtering air and a cover web 120 coupled to a front surface of the filter layer 110.

The filter layer 110 may be provided as a filter formed of a fiber material that is capable of achieving typically demanded filtering effects. The filter layer 110 may also be provided in the form in which a plurality of filters formed of fiber materials that are coupled together by an adhesive or an arbitrary coupling means are laminated as necessary. A first air vent 111 for smooth air flow may be formed in the filter layer 110.

The cover web 120, which is a member coupled to the front surface of the filter layer 110, may be manufactured with a porous fiber material such as non-woven fabric and may protect the filter layer 110 and prevent the filter layer 110 from being spaced apart from the shell structure 200. A second air vent 121 configured to facilitate air flow through a valve 140, which will be described below, may be formed in the cover web 120. In other words, when a user exhales, air may sequentially pass through a third air vent 221, which will be described below, the first air vent 111, and the second air vent 121 and then be discharged to the outside through the valve 140. Therefore, the user may more easily discharge air from the mask to the outside.

Further, the cover web 120 may be coupled to a rear surface of the filter layer 110 as well as to the front surface of the filter layer 110, and the cover web 120 may also be omitted in some cases.

A separate strap 130 may be coupled to the filter structure 100, and the user may wear the mask 1 by hanging the strap 130 on his or her ear.

The valve 140 may be provided at a front surface of the filter structure 100. The valve 140, which is provided to facilitate breathing in a case in which the user breathes while wearing the mask 1, may be provided as a one-way valve that only allows air flow in one direction. For example, the valve 140 may be provided as a one-way valve that is closed when the user inhales and is opened when the user exhales.

Meanwhile, the shell structure 200 for maintaining the overall shape of the mask 1 may be provided at a rear surface of the filter structure 100. At this time, the shell structure 200 may be formed using a molded foam product formed of a non-porous material. For example, the shell structure 200 may be formed using a single member that is formed by vacuum-forming or thermoforming foamed polyolefin. Here, the shell structure 200 may be provided in a cup shape as a whole.

The shell structure 200 may include the circumferential part 210 forming an edge and a curved part 220 formed in an arch shape at an inner side of the circumferential part 210.

The circumferential part 210 may form the edge of the shell structure 200, and a front surface of the circumferential part 210 may be coupled to the rear surface of the filter structure 100. For example, the circumferential part 210 may be heat-welded or ultrasonic-welded to the rear surface of the filter structure 100.

A seating part 211 seated on the user's nose may be formed to protrude from a rear surface of the circumferential part 210. The seating part 211 may be formed to be symmetrical about a vertical central line L1 of the curved part 220. Also, the seating part 211 may be formed by pressing the circumferential part 210. Therefore, an insertion groove 212 may be formed in a shape corresponding to the seating part 211 at a front surface of the seating part 211.

The arch-shaped curved part 220 may be formed at the inner side of the circumferential part 210. Also, the curved part 220 may be integrally formed with the circumferential part 210. For example, the circumferential part 210 and the curved part 220 may be formed using a non-porous single member that is formed by vacuum-forming or thermoforming foamed polyolefin.

At least one opening 221 for air flow may be formed in the curved part 220. The openings 221 may be formed at both sides with respect to the vertical central line L1 of the curved part 220, and the shape and the number of the openings 221 may be changed in various ways as necessary. A protruding part 222 may be formed to continuously protrude along edges of the openings 221 at a rear surface of the curved part 220, and the protruding part 222 may be integrally formed with the curved part 220. The protruding part 222 may increase the stiffness of the curved part 220, in which the openings 221 are formed, and prevent deformation of the openings 221.

A groove part 223 may be formed along the vertical central line L1 of the curved part 220 at the rear surface of the curved part 220. The mask 1 may be easily folded due to the groove part 223. In other words, in a case in which the user grips both sides of the mask 1 and applies an external force thereto to fold the mask 1, since the applied external force is concentrated on the groove part 223, the mask 1 may be folded about the groove part 223 as a reference line. Also, in a case in which the user removes the external force applied to the mask 1, the mask 1 may be restored back to its original shape due to an elastic force of the curved part 220. In this way, the mask 1 according to an embodiment of the present disclosure has the groove part 223 formed at the rear surface of the curved part 220 such that the mask 1 may be easily folded when an external force is applied thereto and may be restored to its original shape when the external force is removed therefrom.

In addition, an auxiliary rib 224 may be formed to protrude from the rear surface of the curved part 220. The auxiliary rib 224 may be integrally formed with the curved part 220 and may be formed at both sides of the groove part 223. The auxiliary rib 224 may increase the stiffness of the curved part 220, thereby preventing a phenomenon in which the mask is folded about a reference line misaligned with the groove part 223.

A front surface of the curved part 220 may be formed to be inclined such that a width of the front surface progressively decreases forward. Therefore, a peak may be formed along the vertical central line L1 of the curved part 220 at the front surface of the curved part 220. The peak may be formed at a position corresponding to the groove part 223. In other words, the groove part 223 may be formed to be inclined such that a width of the groove part 223 progressively decreases forward from the rear surface of the curved part 220, and, corresponding to this, the front surface of the curved part 220 may also be formed to be inclined such that a width of the front surface progressively decreases forward.

The curved part 220 may include a first body 220a which defines both side parts of the curved part 220 and a second body 220b which connects a front side end of the first body 220a and is bent with respect to the vertical central line L1 of the curved part 220. At this time, the groove part 223 and the auxiliary rib 224 may be formed at a rear surface of the second body 220b.

A fiber sheet 300 may be coupled to the rear surface of the shell structure 200. The fiber sheet 330 may be manufactured using synthetic fiber. For example, the fiber sheet 300 may be manufactured using spandex. The fiber sheet 300 may come into direct contact with the face of the user and improve wearability of the mask 1.

Meanwhile, although the case in which the shell structure 200 is formed of a non-porous material has been described above as an example, the shell structure 200 may also be formed of a porous material. An embodiment in which the shell structure 200 is formed of a porous material will be described below with reference to FIGS. 6 to 8.

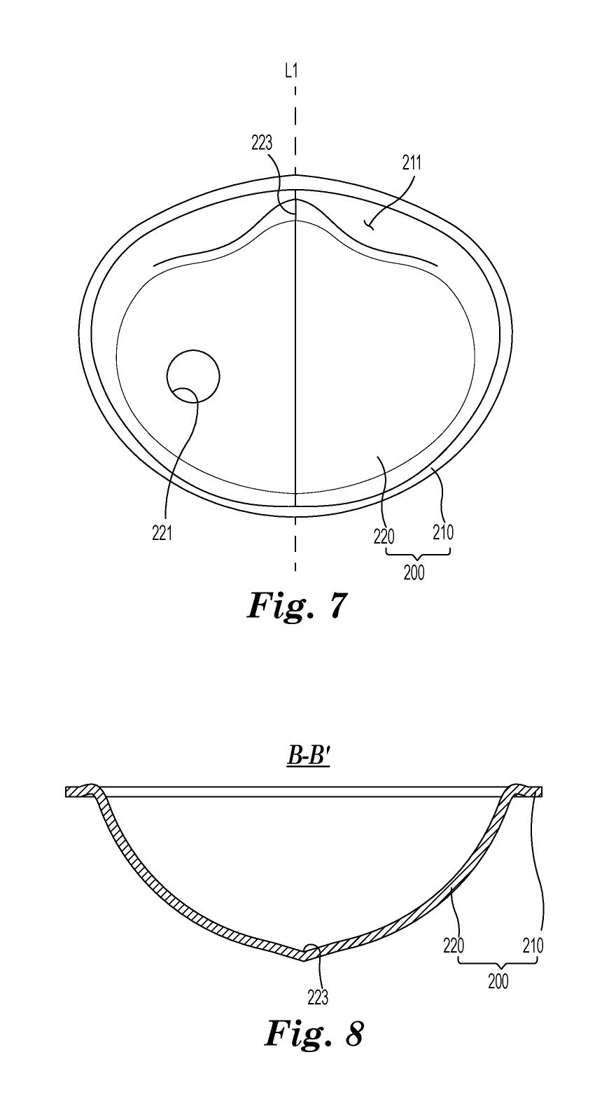

FIG. 6 is an exploded perspective view of a mask according to another embodiment of the present disclosure, FIG. 7 is a rear perspective view of a shell structure according to another embodiment of the present disclosure, and FIG. 8 is a cross-sectional view taken along line B-B′ in FIG. 6. Here, the mask according to the other embodiment of the present disclosure is the same as the mask 1 according to the embodiment of the present disclosure described above with reference to FIGS. 1 to 5 except for the configuration of the shell structure 200. Therefore, detailed descriptions of the same configurations will be omitted and substituted by the above descriptions.

Referring to FIGS. 6 to 8, a shell structure 200 of a mask 1 according to the other embodiment of the present disclosure may be formed using non-woven fabric formed of a porous material. In other words, a circumferential part 210 and a curved part 220 of the shell structure 200 may be manufactured using a single member by press-forming the non-woven fabric formed of a porous material. In this way, in the case in which the shell structure 200 is formed of a porous material, air may enter and exit the mask 1 via the shell structure 200.

The shell structure 200 may include the circumferential part 210 forming an edge and a cup-shaped curved part 220 formed in an arch shape at an inner side of the circumferential part 210. The circumferential part 210 may form the edge of the shell structure 200, and a front surface of the circumferential part 210 may be coupled to a rear surface of a filter structure 100. For example, the circumferential part 210 may be heat-welded or ultrasonic-welded to the rear surface of the filter structure 100.

A seating part 211 seated on the user's nose may be formed to protrude from a rear surface of the circumferential part 210. The seating part 211 may be formed to be symmetrical about a vertical central line L1 of the curved part 220. Also, the seating part 211 may be formed by pressing the circumferential part 210. Therefore, an insertion groove 212 may be formed in a shape corresponding to the seating part 211 at a front surface of the seating part 211.

The curved part 220 may be formed at the inner side of the circumferential part 210 and may be integrally formed with the circumferential part 210. A groove part 223 may be formed along the vertical central line L1 of the curved part 220 at the rear surface of the curved part 220.

A front surface of the curved part 220 may be formed to be inclined such that a width of the front surface progressively decreases forward. Therefore, a peak may be formed along the vertical central line L1 of the curved part 220 at the front surface of the curved part 220. The peak may be formed at a position corresponding to the groove part 223. In other words, the groove part 223 may be formed to be inclined such that a width of the groove part 223 progressively decreases forward from the rear surface of the curved part 220, and, corresponding to this, the front surface of the curved part 220 may also be formed to be inclined such that a width of the front surface progressively decreases forward. In addition, a third air vent 221 for smooth air flow may be formed in the curved part 220. When the user exhales, air may sequentially pass through the third air vent 221, which will be described below, a first air vent 111, and a second air vent 121 and then be discharged to the outside through a valve 140.

The following are lists of embodiments of the present disclosure.

Article 1 is a shell structure including a circumferential part forming an edge, and an arch-shaped curved part integrally formed with the circumferential part at an inner side of the circumferential part, wherein a groove part is formed along a vertical central line of the curved part at a rear surface of the curved part such that the curved part is formed to be foldable about the groove part as a central line.

Article 2 is the shell structure in which the circumferential part and the curved part are formed using a non-porous single member that is formed by vacuum-forming or thermoforming foamed polyolefin and in which at least one opening for air flow is formed in the curved part.

Article 3 is the shell structure in which the curved part includes a first body which defines both side parts of the curved part and a second body which connects a front side end of the first body and is bent with respect to the vertical central line, wherein a groove part is formed at a rear surface of the second body.

Article 4 is the shell structure in which a protruding part is formed to continuously protrude along an edge of the opening at a rear surface of the curved part.

Article 5 is the shell structure formed using non-woven fabric formed of a porous material.

Article 6 is the shell structure in which a front surface of the curved part is formed to be inclined such that a width of the front surface progressively decreases forward.

Article 7 is the shell structure in which the groove part is formed to be inclined such that a width of the groove part progressively decreases forward.

Article 8 is the shell structure in which an auxiliary rib for increasing the stiffness of the curved part is formed to protrude along the vertical central line at both sides of the groove part.

Article 9 is the shell structure in which a seating part seated on a user's nose is formed to protrude from a rear surface of the circumferential part.

Article 10 is the shell structure in which an insertion groove is formed in a shape corresponding to the seating part at a front surface of the seating part.

Article 11 is a mask including the shell structure of Articles 1 to 10 and a filter structure which is coupled to a front surface of the shell structure and performs an air filtering function.

While the shell structure and mask including the same of the present disclosure have been described with reference to specific embodiments thereof, the embodiments are merely illustrative. The present disclosure is not limited thereto and should be interpreted as having the widest possible scope according to the fundamental idea disclosed herein. Those of ordinary skill in the art may combine/substitute the embodiments disclosed herein and practice the embodiments in patterns not described herein, and such patterns are also within the scope of the present disclosure. In addition, those of ordinary skill in the art may easily change or modify the embodiments disclosed herein on the basis of the present specification, and it is apparent that such changes or modifications also belong to the scope of the present disclosure.

What is claimed is:

1. A shell structure, which is provided to maintain a shape of a mask, the shell structure comprising:
a circumferential part forming an edge; and
an arch-shaped curved part integrally formed with the circumferential part at an inner side of the circumferential part,
wherein a groove part is formed along a vertical central line of the curved part at a rear surface of the curved part such that the curved part is formed to be foldable about the groove part as the center.

2. The shell structure of claim 1, wherein:
the circumferential part and the curved part are formed using a non-porous single member that is formed by vacuum-forming or thermoforming foamed polyolefin; and
at least one opening for air flow is formed in the curved part.

3. The shell structure of claim 2, wherein the curved part includes:
a first body which defines both side parts of the curved part; and
a second body which connects a front side end of the first body and is bent with respect to the vertical central line,
wherein the groove part is formed at a rear surface of the second body.

4. The shell structure of claim 2, wherein a protruding part is formed to continuously protrude along an edge of the opening at a rear surface of the curved part.

5. The shell structure of claim 1, wherein the shell structure is formed using non-woven fabric formed of a porous material.

6. The shell structure of claim 1, wherein a front surface of the curved part is formed to be inclined such that a width of the front surface progressively decreases forward.

7. The shell structure of claim 1, wherein the groove part is formed to be inclined such that a width of the groove part progressively decreases forward.

8. The shell structure of claim 1, wherein an auxiliary rib for increasing a stiffness of the curved part is formed to protrude along the vertical central line at both sides of the groove part.

9. The shell structure of claim 1, wherein a seating part seated on a user's nose is formed to protrude from a rear surface of the circumferential part.

10. The shell structure of claim 9, wherein an insertion groove is formed in a shape corresponding to the seating part at a front surface of the seating part.

11. A mask comprising:
a shell structure of any one of claims 1 to 10; and
a filter structure which is coupled to a front surface of the shell structure and performs an air filtering function.
